(19) United States
(12) Patent Application Publication
(10) Pub. No.: US 2016/0247067 A1
(43) Pub. Date: Aug. 25, 2016

(54) METHOD AND SYSTEM FOR INTELLIGENT CRANE LIFTING

(71) Applicants: NANYANG TECHNOLOGICAL UNIVERSITY, Singapore (SG); PEC LIMITED, Singapore (SG)

(72) Inventors: Yiyu CAI, Singapore (SG); Panpan CAI, Singapore (SG); Chandrasekara INDHUMATHI, Singapore (SG); Jianmin ZHENG, Singapore (SG); Nadia M. THALMANN, Singapore (SG); Peng WONG, Singapore (SG); Teng Sam LIM, Singapore (SG); Yi GONG, Singapore (SG)

(21) Appl. No.: 15/027,373

(22) PCT Filed: Oct. 8, 2014
(86) PCT No.: PCT/SG2014/000472

§ 371 Date: Apr. 5, 2016

Related U.S. Application Data
(60) Provisional application No. 61/888,293, filed on Oct. 8, 2013.

(51) Int. Cl. G06N 3/12; G06F 17/50

(52) U.S. Cl. CPC G06N 3/126; G06F 17/5004

(57) ABSTRACT

A method is proposed for automatically generating a crane lifting path describing the motion of a crane. The method includes: laser scanning a plant to generate one or more point clouds; using the point clouds to identify objects to be lifted by the crane; rasterizing the laser scanned point clouds to generate digital data describing the plant and in a format for input to a Graphics Processing Unit (GPU); and iteratively optimizing a crane lifting path, including using the GPU and the digital data to detect collisions between one or more cranes and the plant if the crane follows the crane lifting path.

### CROSS-REFERENCE TO RELATED APPLICATIONS

The present application is a filing under 35 U.S.C. 371 as the National Stage of International Application No. PCT/SG2014/000472, filed Oct. 8, 2014, entitled “METHOD AND SYSTEM FOR INTELLIGENT CRANE LIFTING,” which claims priority to U.S. Provisional Application No. 61/888,293 filed Oct. 8, 2013, both of which are incorporated herein by reference in their entirety for all purposes.

### FIELD OF THE INVENTION

The present invention relates to methods and systems for planning a crane lifting path for moving an object using a crane. It further relates to systems and methods for implementing the lifting. The invention can be used to implement maintenance services for a plant in the petro-chemical, pharmaceutical and manufacturing industries, to determine an intelligent crane lift plan, and thus improve the plant's productivity.

### BACKGROUND OF THE INVENTION

Modern petro-chemical, pharmaceutical and manufacturing plants are constructed by computer-aided design (CAD) and typically represented by a plant design management system (PDMS). During the life cycle of the plants, parts or objects of the plants need to be replaced or changed for various reasons. Cranes are widely used to lift parts or objects for plant maintenance service. Safety and productivity are two central issues with any crane lifting job. Determining a collision-free lifting path of cranes is challenging especially with highly complex plants.

Crane lift planning is determining a collision-free path or trajectory for the part or object to travel from an original place to a destination by maneuvering the crane. Currently, a crane lift plan is typically produced by a team consisting of a manager, an engineer, an operator, a signalman and a rigger through trial-and-error based on their prior experience. Identifying a lifting plan involves the identification of a global optimal solution from all possible collision-free crane lifting paths.

The major difficulty of crane lift planning lies in the high complexity of the plant. Collision detection (CD) is a bottleneck problem for lift planning. Fast detection of possible collisions between the moving crane (plus the lifted object/part) and the plant is highly desirable, especially for a complex plant.

Commonly used collision detection algorithms are categorized into two classes: object-space algorithms and image space algorithms. The basic strategy of object space collision detection algorithms is to compare pair-wise geometric primitives composed of triangles. A robust way is to consider all possible pairs of primitives. This will work for a small number of triangles, but if the objects have complex shapes or there are a large number of primitives, it is hard to achieve results within an acceptable time. To improve the efficiency, the object CD process is divided into two phases: the broad phase and the narrow phase [1]. The major task of the broad phase is culling possible colliding pairs or number of triangles for which it is necessary to perform a detailed test. This aim is realized by introducing acceleration data structures such as bounding volume hierarchies (BVH) [2-4] and spatial partitioning [5-7]. Ming C. Lin [8] suggested the use of axis-aligned bounding boxes for collision detection which use a box that fully and tightly contains the object to represent the object for collision checking. Octrees (octal space-partitioning hierarchy) [5] is one example of spatial partitioning hierarchies. Vemuri [8] in University of Florida utilized the Octrees instead of regular spatial grids in collision detection for reduced memory cost and higher efficiency. The narrow phase runs the same task as the previous method: detecting interferences between pairs or groups of primitives. More efficient test methods such as separating axes tests, separating plane tests and proximity tests may replace the direct test between vertices, edges and faces [1-3].

Image-space collision detection algorithms explore computing platforms such as on multi-core CPUs [10-13] and GPUs. Since 2003 researchers such as Fauer and Govindaraju [1, 10, 14] have investigated the potential of relying on GPU platforms to speed up collision detection, and have achieved impressive results. Most hardware-assisted image-space collision detection methods make use of OpenGL buffers such as a depth buffer, a stencil buffer or a color buffer [14, 15]. Cai, et al. [16] proposed an image-space method using multiple projections to handle convex objects. However, these methods require data read-back which is often time consuming due to the asymmetric accelerated graphics port buses in common graphic cards. Moreover, these methods can only be applied to convex objects. The algorithm relies highly on the shape of objects. To achieve correct collision results for complex shapes, the number of projection screens required could be very large.

Lift planning of mobile cranes is traditionally conducted by big planning teams using sketches and site investigations [17]. Several days would be spent on the planning process doing investigation, sketching, discussion and confirmation. Interactive planning software [18, 20] may help to speed up the process by assisting in load monitoring, ground pressure checking, rigging designing and so on. Automated lift planning tools will bring tremendous improvement in the efficiency of lift planning. Reddy [21] investigated the possibility of using of a genetic algorithm in solving the lift planning problem and shows a promising result. However, Reddy's algorithm is very time-consuming thus is not applicable in real plants.

As noted above, using computer-aided design software, plants can be designed in as digital form such as a Plant Design Management System (PDMS) or as a “Smart Plant” (a similar standard used in certain states) before the physical version of the plants are constructed. However, there exist plants with no CAD, PDMS or Smart Plant models available. Lasers are increasingly utilized to scan such physical plants forming digitized plants in the form of point clouds. GPU [22-25] technology can play an important role in the digital representation of plants, cranes and loads.

By rasterization, plants in point clouds or PDMS/Smart Plant forms, can be converted to depth maps. Through digital geometry processing [26, 33-35], cranes in traditional CAD form can be represented in meshes. Loads (objects or parts) before they are delivered to a target site are usually modeled in CAD form, and thus can be converted to a mesh representation through similar digital geometry processing. They can be converted to GPU rasterized digital objects or parts once delivered to their destination.

### SUMMARY OF THE INVENTION

The present invention aims to provide a new and useful method of planning an operation of moving an object using a crane.

In particular, the method proposes a process of generating a crane lifting path in which the data describing the plant and preferably the object, is presented in a rasterized format (that is, as a multi-layer depth map), and the optimization is then performed iteratively by generating and testing candidate crane lifting paths, using a Graphics Processing Unit (GPU) to detect collisions between the one or more cranes and the plant.

In preferred embodiments of the invention, the crane lifting path optimization is realized by a novel parallel Genetic Algorithm, based on CUDA (compute unified device architecture) programming. Note that the known methods described of using a GPU described above, are for collision detection, not for path planning optimisation. The known method of optimization using a genetic algorithm [21] was not parallelized, and had a different formulation of the optimization problem from that of typical embodiments of the present invention.

The invention may be used in plants for which a PDMS or Smart Plant model exists including the location of an object to be movel. However, in many important applications of the invention, such data describing the plant and/or the object does not pre-exist. In this case, the invention proposes prior steps of laser scanning the plant, identifying the object (preferably including extracting data about the objects from a database, where available), forming data describing the plant, and a rasterization process of converting the data into a format suitable for input into the GPU.

Preferably, the raterization process is performed after the step of identifying the object, although in principle it can be performed first, i.e. such that the step of identifying the object uses the rasterized data.

Thus, one expression of the invention is a method of generating a crane lifting path which includes the steps of:
1) laser scanning of a plant to generate one or more point clouds;
2) identifying objects to be lifted from the point clouds;
3) extracting further information about the objects from a database (e.g. a Plant Design Management System), if one is available;
4) rasterizing the laser scanned point clouds to generate digital data describing the plant in digital format suitable for lifting path planning with the aid of a Graphics Processing Unit (GPU); and
5) iteratively optimizing the a crane lifting path, including using the GPU to detect collisions between one or more cranes, and the rasterized plant.

Preferred embodiments of the invention permit the intelligent planning of a globally optimized crane lifting path through accurate lifting object identification, real-time collision detection independent of the plant complexity, and global optimized lifting path determination.

The accurate lifting object identification is achieved in preferred embodiments of the invention by novel segmentation and pattern recognition techniques of digital geometry processing. Real-time collision detection is guaranteed by GPU accelerated rasterization which is independent of the plant complexity.

In embodiments of the invention, the rasterization process may be also performed by a CUDA, using the GPU. This is in contrast to the known methods described above which use OpenGL rendering, which also can generate depth maps but which read data back to the CPU side. The present invention may avoid read-back.

Embodiments of the invention take advantage of digitization. With the aid of GPU, crane lift planning becomes independent of the complexity of the plant. The GPU-enabled digital plant representation makes collision detection extremely simple. In addition, GPU technology enables parallelization to speed up the Genetic Algorithm based optimization process which is traditionally computationally expensive.

By means of embodiments of the invention, end users may benefit from the solution to shorten the operation time in plant maintenance, thus increasing productivity, and improving worksite safety.

The invention can be expressed as a method for generating a crane lifting path. The method may be performed automatically; that is, without human involvement except perhaps for initiating the method.

The invention may alternatively be expressed as a computer (such as a general purpose computer) comprising a data storage device storing program instructions for implementation by the processor to cause the processor to carry out the method, and thereby output an optimized the crane lifting path. The system may further include the crane itself, and the output crane lifting path may be transmitted to the crane, for performance by the crane.

The invention can be applied to the field of maintenance service in petro-chemical, pharmaceutical and manufacturing industries to determine an intelligent and optimal crane lift plan, and thus improve their productivity. One potential commercial application of the invention is to install a processor arranged to perform the invention in a crane. The invention can also be used for safety training with crane operation teams.

### BRIEF DESCRIPTION OF THE DRAWINGS

An embodiment of the invention will now be described for the sake of example only with reference to the following figures, in which:

FIG. 1 is a flow diagram of an embodiment of the invention.

FIG. 2 is a flow diagram showing in more detail certain steps of the method of FIG. 1.

FIG. 3 illustrates a digitization process for plant digitization (rasterization) using triangle mesh.

FIG. 4 illustrates a digitization process used in the process of FIG. 2 using a point cloud model.

FIG. 5 is a flow diagram showing determination of an optimal trajectory for a trailer/long vehicle (including cranes) between 2 endpoints in the road region of a plant.

FIG. 6 shows the work flow of a collision detection process.

FIG. 7 illustrates an iterative operation optimization step which is part of the process of FIG. 1.

### DETAILED DESCRIPTION OF THE EMBODIMENTS

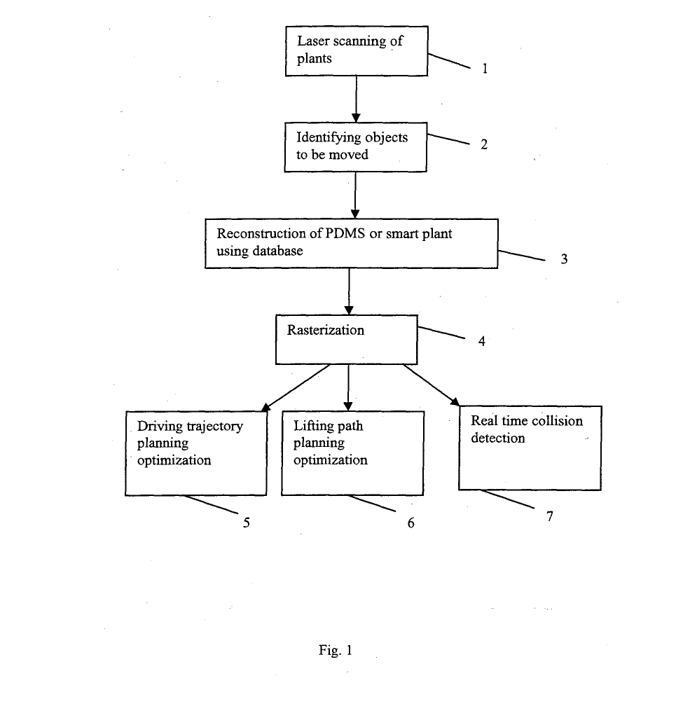

Referring firstly to FIG. 1, an embodiment is shown of the overall process carried out by the invention. Although the explanation refers to multiple graphics processing units (GPUs) it is to be understood that any number of GPUs may be used (including just one), with the work being allocated between them appropriately on a time-sharing basis.

In a first step (step 1) there is a laser scanning of the plant to produce a “point cloud”, showing the three-dimensional locations of points in the plant. In step 3, the objects in the plant to be moved are identified, and any available information about the objects is extracted from a database. In step 4 any available information about the plant (e.g. PDMS or Smart Plant) is extracted from a database and used to refine the point cloud. The result (or the point cloud itself if there is no such available information) is referred to as the “digital map” of the plant.

In step 4, the results are rasterized (this process is also referred to here as “digitization”) to produce a well-formatted multi-layer depth map.

The result is used for three processes: driving trajectory planning optimization (step 5) in which the motion of the crane as it is driven along pre-defined road regions within the plant is planned; lifting path optimisation (step 6) including using a GPU to detect candidate lifting paths which cause a collision; and real time collision detection as the object is moved (step 7).

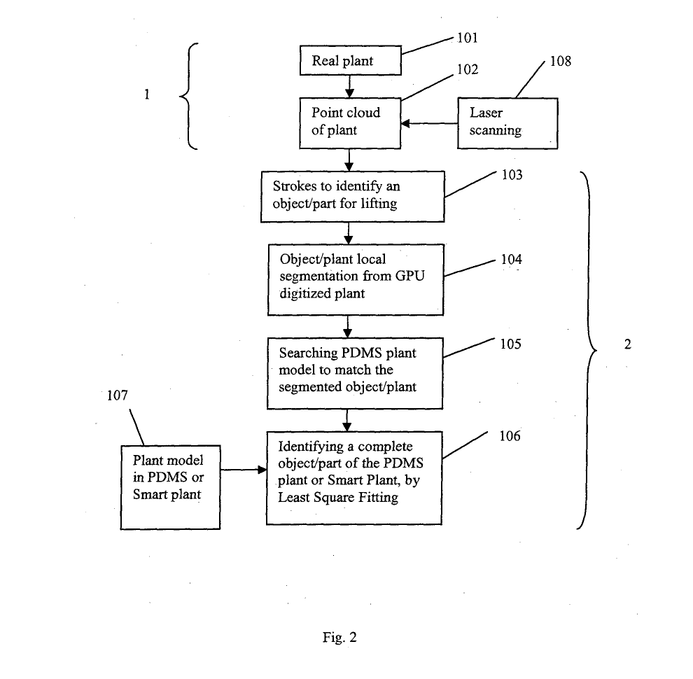

Steps 1 and 2 for identifying the object to be lifted are illustrated in more detail in FIG. 2. The object can be represented by either a PDMS (or Smart Plant) or a Point Cloud. As noted above, the embodiment starts with a real plant 101, which is subject to laser scanning 108 to generate point clouds of the plant 102.

In step 1, the point clouds are used to identify a specific object/part to be removed from the plant. First, in a manual process (performed for example with a mouse) strokes 103 are interactively introduced, to approximately segment the specific object/part from the point clouds based GPU plant. This is typically the last stage of the embodiment which involves human iteraction, and the following steps are performed automatically.

The segmented object/part 104 is then used to search 105 for the corresponding object/part in a PDMS/Smart plant database of the plant 107 (when available). Least squares fitting is performed to identify the best match of the complete object/part 106 in the PDMS plant.

In step 3, the point cloud and any available data are combined to produce a “digital plant”. Note that all of steps 1, 2 and/or 3 may be omitted in the case that the respective data is already available; for example, if PDMS or Smart Plant data exists fully describing the plant, including the location of the object.

The results of these process are then rasterized in a rasterization step (step 4) to generate a multi-level depth map.

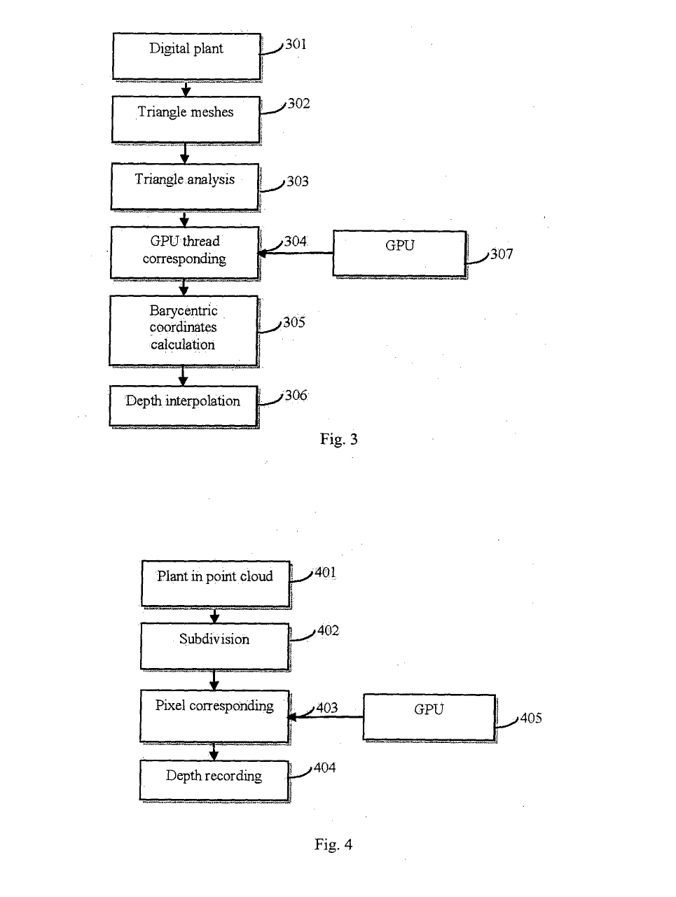

FIG. 3 illustrates the rasterization process for a triangle mesh based digital models, such as a CAD model of the cranes or PDMS/Smart-Plant data which is in the form of a triangle mesh. The inputs to the process are represented as a digital plant 301 and triangle mesh 302. In this case, digitization contains two phases: triangle analysis and triangle rasterization. The triangle analysis stage 303 prepares information of triangles that is needed for triangle rasterization including their correspondence with pixel blocks and edge function parameters. This process is handled in a GPU 307 with each thread dealing with one triangle 304. The triangle rasterization phase queries through all pixels in the corresponding pixel block. Barycentric coordinates of the pixel position are calculated 305 by solving a linear equation system. The coordinates are used for interpolating 306 the depth value of the pixel position on the triangle. In this stage, each triangle is handled by one GPU thread warp with threads in the warp querying pixels in parallel.

For point cloud digital models such as those generated by laser scans, a similar digitization process is applied as illustrated in FIG. 4. The plant cloud 401 encoding the plant is sub-divided 402. Then each GPU thread of a GPU 405 deals with one respective 3D point, calculating 403 its nearest pixel and storing 404 the depth value in a depth map. To make sure that the depth value stored in the depth map is the highest one, atomic memory synchronization is applied in the GPU function.

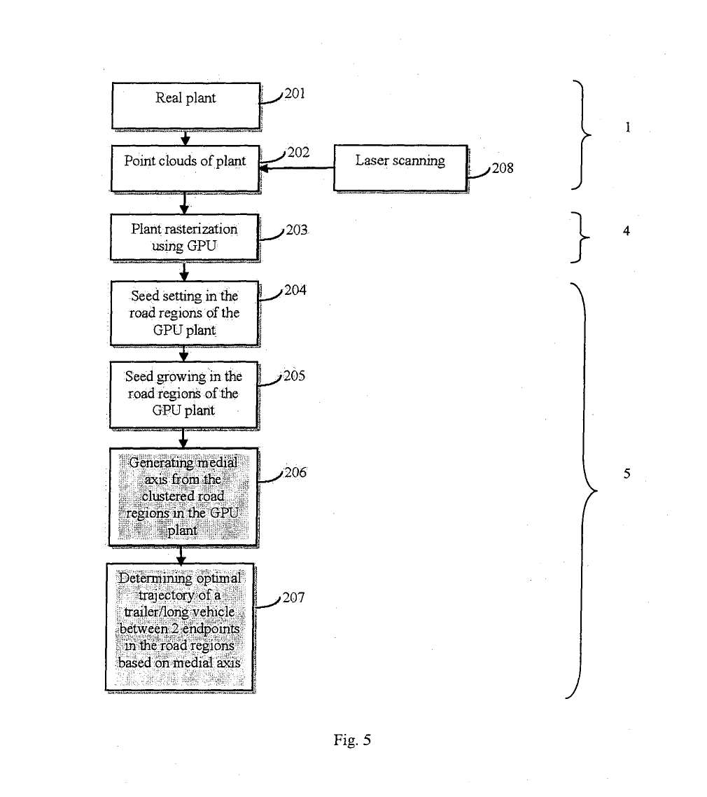

The general procedure for determining an optimal trajectory for a trailer/long vehicle (including cranes) to travel between a start point and an end point in a road region of a plant (step 5) may be summarized in FIG. 5.

The starting point of step 5 is the result of the process of step 1 (which is denoted in FIG. 5 as steps in which the real plant 201 is scanned using a laser scanner 208 to generate point clouds of the plant 202) and the rasterization process (step 4) denoted as 203.

In step 5, seed setting is performed 204 in the road region interactively, followed by a seed growing process 205 to cluster the road region. A medial axis 206 is generated from the clustered road region. An optimal trajectory 207 is then computed based on the medial axis and the clustered road region for the trailer/long vehicle to travel between two endpoints.

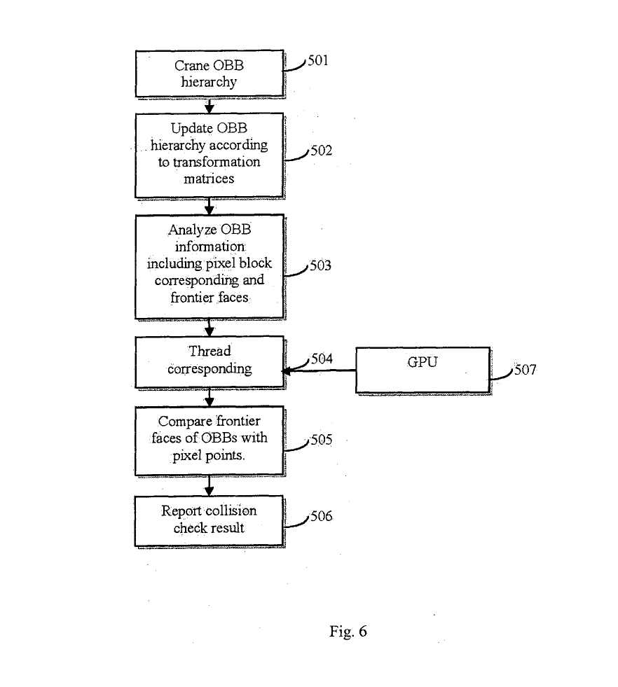

Before discussing step 6 (the lifting path planning), we will discuss, with reference to FIG. 6, a collision detection process which is used both in step 6 and to perform step 7 (real time collision detection).

With a GPU digitized plant, crane and load data readily available, collision detection becomes crucial when using a crane to lift a load in a plant. GPU technology can be used to determine collision-free lifting paths in real-time. Due to GPUs' naturally parallel-styled design, the embodiment uses a General Purpose GPUs (GPGPUs) given the complex nature of the plant environment. The embodiment uses CUDA (Compute Unified Device Architecture) APIs (application programming interfaces) to implement the approach for easy GPU memories allocation and parallelization [24]. The embodiments combine an oriented bounding box (OBB) technique and depth map for collision detection. The GPU permit real-time runtime collision checking. Here the digitized plant, the digitalized crane, and the digitized load make the collision detection extremely simple and effective. A major advantage of our approach is that it is independent of the complexity of the plant.

In the beginning of the collision detection process, all the OBBs of crane components 501 are updated 502 according to transformation matrices. Then a GPU kernel is launched to compute 503 the pixel block correspondence and the bottom faces of the OBBs which are frontiers of collision with the depth mask. Then a GPU kernel 504 is launched with threading corresponding to pixels. This is performed using a GPU 507. The threads compare 505 information in the depth maps with frontiers of the OBB. Once contact happens between the faces and the depth mask, the kernel will report 506 collision and related information.

Note that when an object has been lifted by a crane then it is considered part of the crane, and the OBB of the crane is modified accordingly.

The algorithm above can also be used to detect not just actual collisions between the cranes and the plant, but to obtain numerical values for proximity (this option is used when step 6 is performed). It is done by imagining, for each crane, a set of nested OBBs which are identical in shape, and centred on the same position, but which differ in size. The smallest of the OBBs is the original OBB of the crane (plus any object the crane is carrying). If the process of FIG. 5 discovers that this OBB does not suffer a collision, but that a collision occurs if the smallest OBB is replaced by an OBB which is at least a certain amount larger, then the proximity of the crane to the plant can be determined, and is denoted by a value p.

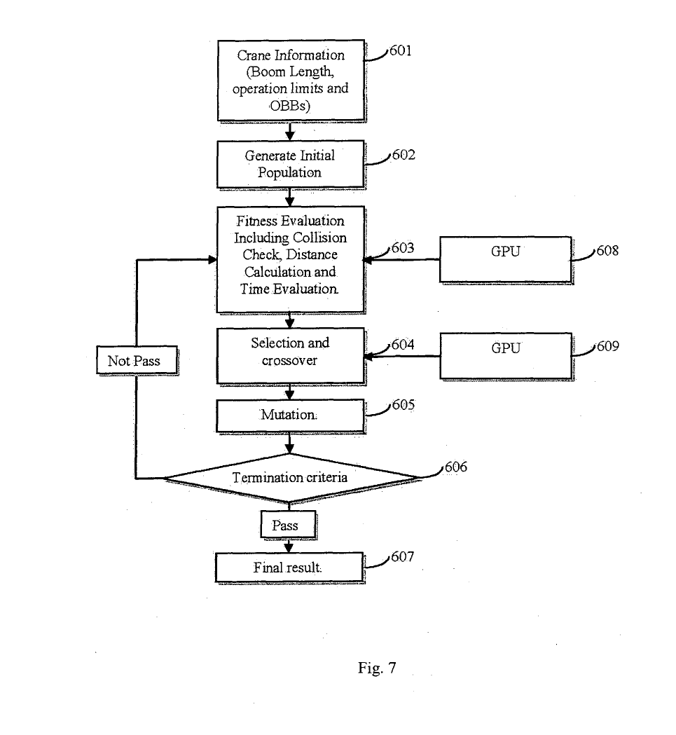

We now turn to a description of the step 5 of FIG. 1: automatic determination of the global optimized crane lifting path. A detailed flow diagram of this step is provided in FIG. 7.

A Genetic Algorithm (GA) is used to solve many global optimization problems [27-32]. In the present embodiment, a master-slave parallel GA is chosen to fulfill the task of fast global optimized lift planning. The overall procedure of GA is controlled by a CPU while computational intensive parts, especially collision detection, are handled by parallel threads.

Referring to FIG. 7, inputs to the process include crane information 601 (e.g. the boom length, operation limits and OBB). These are used to generate 602 an initial population of candidate crane lifting paths. A GPU 608 then performs fitness evaluation 603 using an objective function. The candidate crane lifting paths which are found to have high fitness are used by a GPU 609 to provide selection and cross-over 604. There is then a mutation step 605, also done by the GPU 609. In step 606 it is determined whether a termination criterion is met. If so, the candidate fitness algorithm with the highest fitness score is labeled as a “pass” result, and is the final result 607 output from the embodiment. If not, the optimization process reverts to step 603, using the new candidate crane lifting paths generated in steps 604 and 605.

In the fitness evaluation, each candidate crane lifting path is represented as a linear chromosome in a GA. Each candidate lifting path is represented as a linear chromosome with n genes, labeled by i=1, . . . n, where n is the number of operations of the candidate lifting path. Thus, each gene represents a single operation carried out on the object by the crane, so that the lifting path is the series of the successive operations. Each gene (say the i-th gene) consists of three parameters, and is represented as (a_{S}ⁱ,a_{L}ⁱ,l_{H}ⁱ). a_{S}ⁱ and a_{L}ⁱ denote the total amount of swinging and luffing the object has experienced following the i-th operation.

The GA uses an objective function. The objective function of the optimization problem is characterized by various factors including complexity of operations, time, energy cost, and safety risks. The motion of lifting operation can be furthered divided into various types.

First, there is a motion cost C_{Motion} of the operation trajectory, defined as:

$${C}_{Motion} = {w}_{S} {L}_{S} + {w}_{L} {L}_{L} + {w}_{H} {L}_{H} ( + {w}_{LS} {L}_{LS} ) \\ {L}_{*} = {\sum }_{i = 1}^{n} \vert {α}_{*}^{i} - {α}_{*}^{i} \vert , where {}^{*} ∈ \{ S , L , LS \} \\ {L}_{H} = {\sum }_{i = 1}^{n} \vert {𝓁}_{H}^{i} - {𝓁}_{H}^{i - 1} \vert \qquad ( 1 )$$

The final term is a cost related to load swinging. It is shown in brackets because it is only applicable for an operation at a time when an object is carried by the crane. For such operations an additional parameter is added to the i-th gene. w_{S}, w_{L}, w_{H}, w_{LS} represent the weight for swinging, luffing, hoisting, and load swinging, respectively.

Second, there is a time cost which consists of both operation time and operation switching time. The time cost of a specific operation is decided by both the angle or length changed and the speed of the operation. The cost can be represented as:

C_{Time}=L_{S}/v_{S}+L_{L}/v_{L}+L_{H}/v_{H}(+L_{LS}/v_{LS})+N₀t₀ (2)

Again, the term involving L_{LS}/V_{LS} is in brackets here to indicate that it is only applicable when a load is being carried. Here C_{Time} denotes the time cost of the operation trajectory and v_{S}, V_{L}, v_{H}, v_{LS} stand for the speed of swinging, luffing, hoisting and load swinging respectively. N₀ and t₀ represent the number of operation switches and the time cost for each switch. Note that N₀ is at most equal to n.

Safety risk concerns the proximity of the crane to the plant structure and can be represented as:

$${C}_{Safety} = {\sum }_{i = 0}^{n} g ( p ( {β}_{i} ) )$$

where p stands for the proximity obtained using the method of FIG. 6 and g is an increasing function.

Continuous modeling of the risk is performed using an accurate proximity test. Discretizing the proximity can simplify the modeling. Multi-level proximity information can be obtained from the collision detection algorithm. Thus we can define the safety risk by making use of this information:

$${C}_{Safety} = \{ \begin{matrix}0 , & distance to plant > 300 cm \\ {c}_{1} , & 300 cm > distance to plant > 100 cm \\ {c}_{2} , & distance to plant < 100 cm\end{matrix} \qquad ( 3 )$$

C_{Safety} represents the cost brought by safety risks. c₁ and c₂ are some constant value where c₂>c₁.

Combining equations (1), (2) and (3), we obtain the representation of the objective function of the lift planning problem:

f(S_{O})=C_{Motion}+C_{Time}+C_{Safety} (4)

In sub-step 604, roulette wheel selection is applied on strings with the same fitness value. The genetic operators involved are parameter-based crossover which selects better genes from parents and embeds them in the offspring locus. In sub-step 605 both normal independent mutation and a smoothing mutation are applied. The smoothing mutation takes a convex combination of neighboring genes and replaces the original gene at the locus.

Note that this optimization process again takes advantage of GPU technology for high performance through parallelization.

### REFERENCES

The disclosure in the following references is incorporated herein in its entirety:
[1] Govindaraju, N. K., Redon, S., Lin, M. C. & Manocha, D. CULLIDE: Interactive collision detection between complex models in large environments using graphics hardware. in Proceedings of the ACM SIGGRAPH/EUROGRAPHICS conference on Graphics hardware. 25-32 (Eurographics Association).
[2] Tang, M., Manocha, D. & Tong, R. MCCD: Multi-core collision detection between deformable models using front-based decomposition. Graphical Models 72, 7-23 (2010).
[3] Tang, M., Manocha, D., Lin, J. & Tong, R. Collision-streams: fast gpu-based collision detection for deformable models. in Symposium on Interactive 3D Graphics and Games. 63-70 (ACM) (2011).
[4] Gottschalk, S., Lin, M. C. & Manocha, D. OBBTree: a hierarchical structure for rapid interference detection. in Proceedings of the 23rd annual conference on Computer graphics and interactive techniques. 171-180 (ACM). (1996).
[5] Hunter, G. M. Efficient computation and data structures for graphics. (1978).
[6] Jung, D. & Gupta, K. K. Octree-based hierarchical distance maps for collision detection. in Robotics and Automation, 1996. Proceedings., 1996 IEEE International Conference on. 454-459 (IEEE).
[7] Zhou, K., Gong, M., Huang, X. & Guo, B. Data-parallel octrees for surface reconstruction. Visualization and Computer Graphics, IEEE Transactions on 17, 669-681 (2011).
[8] Lin, M. C. E cient Collision Detection for Animation and Robotics, Citeseer, (1993).
[9] Vemuri, Baba C., Chen, L, Vu-Quoc, L, Zhang, X & Walton, O. Efficient and accurate collision detection for granular flow simulation. Graphical models and image processing 60, 403-422 (1998).
[10] Faure, F., Barbier, S., Allard, J. & Falipou, F. Image-based collision detection and response between arbitrary volume objects. in Proceedings of the 2008 ACM SIGGRAPH/Eurographics Symposium on Computer Animation. 155-162 (Eurographics Association).
[11] Thomaszewski, B., Pabst, S. & Blochinger, W. Parallel techniques for physically based simulation on multi-core processor architectures. Computers & Graphics 32, 25-40 (2008).
[12] Avril, Q., Gouranton, V. & Arnaldi, B. New trends in collision detection performance. VRIC'09 Proceedings 11 (2009).
[13] Guy, S. J., Chhugani, J., Kim, C., Satish, N., Lin, M., Manocha, D. & Dubey, P. Clearpath: highly parallel collision avoidance for multi-agent simulation. in Proceedings of the 2009 ACM SIGGRAPH/Eurographics Symposium on Computer Animation. 177-187 (ACM).
[14] Heidelberger, B., Teschner, M. & Gross, M. Real-time volumetric intersections of deforming objects. in Proc. of Vision, Modeling and Visualization.
[15] Baciu, G., Wong, W. S. K. & Sun, H. RECODE: an image-based collision detection algorithm. in Computer Graphics and Applications, 1998. Pacific Graphics' 98. Sixth Pacific Conference on. 125-133 (IEEE).
[16] Vassilev, T., Spanlang, B. & Chrysanthou, Y. Fast cloth animation on walking avatars. in Computer Graphics Forum. 260-267 (Wiley Online Library).
[17] Ministry of Manpower, Singapore, WSHCOUNCIL <https://www.wshc.sg/cms/Liftingplan>.
[18] CRANIMAX, CRANE MANAGER 2011 Homepage <http://www.cranimax.com/produkte/cranimation/en_produkt_cranimation.php>.
[19] A1A Software, 3D Lift Plan Homepage <http://www.3dliftplan.com/>.
[20] Markus Scholl, kranXpert Homepage <http://www.kranxpert.de/>.
[21] Reddy, H. R. & Varghese, K. Automated path planning for mobile crane lifts. Computer-Aided Civil and Infrastructure Engineering 17, 439-448 (2002).
[22] Wong, W. S. K. & Baciu, G (2005). GPU-based intrinsic collision detection for deformable surfaces. Computer Animation and Virtual Worlds 16, 153-161.
[23] Sanders, J. & Kandrot, E (2010). CUDA by example: an introduction to general-purpose GPU programming. Addison-Wesley.
[24] Le Grand (2007)., S. Broad-phase collision detection with CUDA. GPU Gems 3, 697-721
[25] YY Cai, Z W Fan, H G Wan, S M Gao, B F Lu, K T Lim (2006), Hardware-accelerated collision detection for 3D virtual reality gaming, Simulation and Gaming 37 (4): 476-490.
[26] P Chiang, J Zheng, K Mak, N Thalmann, Y Cai (2012), Progressive Surface Reconstruction for Heart Mapping Procedure, Computer-aided Design 44: 289-299.
[27] Holland, J. H (1992). Genetic algorithms. Scientific American 267, 66-72.
[28] Biegel, J. E. & Davern, J. J. (1990), Genetic algorithms and job shop scheduling. Computers & Industrial Engineering 19, 81-91.
[29] Poon, P. W. & Carter, J. N. (1995), Genetic algorithm crossover operators for ordering applications. Computers & Operations Research 22, 135-147.
[30] Hamidinia, A., Khakabimamaghani, S., Mazdeh, M. M. & Jafari, M. (2012), A genetic algorithm for minimizing total tardiness/earliness of weighted jobs in a batched delivery system. Computers & Industrial Engineering 62, 29-38.
[31] Renders, J. M. & Flasse, S. P. (1996), Hybrid methods using genetic algorithms for global optimization. IEEE Transactions on Systems, Man, and Cybernetics, Part B: Cybernetics, 26, 243-258.
[32] Mühlenbein, Heinz, Schomisch, M & Born, Joachim (1991). The parallel genetic algorithm as function optimizer. Parallel computing 17, 619-632.
[33] J. Zhang, J. Zheng, C. Wu, J. Cai (2012), Variational mesh decomposition, ACM Transactions on Graphics (presented at SIGGRAPH 2012) 31(3).
[34] J Zheng, Y Cai (2006), Interpolation Over Arbitrary Topology Meshes Using a Two-Phase Subdivision Scheme. IEEE Transactions on Visualization and Computer Graphics 2(3): 301-310.
[35] Y Cai, N Chia, D Thalmann, N Kee, J Zheng et al (2013), Design and Development of A Virtual Dolphinarium for Children with Autism, IEEE Transaction on Neural System and Rehabilitation.
[36] P Chiang, J Zheng, Y Yu, K Mak, C Chui, Y Cai (2012), A VR Simulator for Intra-Cardiac Intervention: Concept, Design and Implementation, IEEE Computer Graphics & Applications 33(1): 44-57.
[37] Y Cai & J Brown (editors), VR Simulation & Gaming, Special Issue with the Journal Simulation and Gaming, SAGE Publisher, 2006.[36] P. Cai, Y Cai, et al. (2012). A Framework of the Crane Simulator Using GPU-based Collision Detection, Asia-Europe Workshop on Serious Game & Simulation, CASA 2012.

1. A method of generating a crane lifting path describing the motion of a crane carrying an object within a plant, the method comprising:
(i) forming a model of a plant and a model of the crane, wherein the model of the plant comprises a multi-level depth map containing rasterized data;
(ii) iteratively optimizing a crane lifting path describing a motion of the crane within the plant,
the iterative optimization being performed using the models and at least one graphics processing unit (GPU), to detect collisions between the crane and the plant if the crane follows the crane lifting path.

2. A method according to claim 1 further including, before steps (i) and (ii), the steps of:
laser scanning the plant to generate one or more point clouds;
using the point clouds to identify an object to be lifted by the crane; and
rasterizing the laser scanned point clouds to generate the model of the plant.

3. A method according to claim 1 further including extracting further information about the identified objects from a database.

4. A method according to claim 1 in which the iterative optimization algorithm is a genetic algorithm, in which a plurality of candidate crane lifting paths are evaluated using an objective function, and according to the results new candidate crane lifting paths are generated until a termination criterion is met.

5. A method according to claim 4 in which the objective function of each candidate crane lifting path is a function of at least one of (i) a motion cost indicative of a total distance included in the candidate crane lifting path, and (ii) a time cost indicative of a time taken to implement the candidate crane lifting path.

6. A method according to claim 4 in which the objective function of each candidate crane lifting path further includes a safety cost indicative of the proximity of the crane to the rasterized plant when implementing the candidate crane lifting path.

7. A method according to claim 1 in which, to describe a portion of the crane lifting operation in which the crane is lifting an object, the model of the crane is modified to be a model of the crane and the object.

8. A system comprising a processor and a data storage device storing computer program instructions, the instructions being operative, when performed by the processor, to cause the processor to perform a method according to any preceding claim, to generate and output a crane lifting path.

9. A system according to claim 8 further comprising at least one crane which is configured to implement the crane lifting path.

10. A system according to claim 9 in which the crane is provided with a GPU arranged to detecting real time collisions between the crane and the plant using a multi-level depth map of the crane and the plant.

11. A method according to claim 1 in which the model of the crane comprises an oriented bounding box of the crane.
